(19) United States
(12) Patent Application Publication
(10) Pub. No.: US 2015/0066612 A1
(43) Pub. Date: Mar. 5, 2015

(54) SYSTEM AND METHOD FOR INTERFACING WITH STUDENTS PORTFOLIOS

(71) Applicant: Laureate Education, Inc., Baltimore, MD (US)

(72) Inventors: RISSA E. KARPOFF, Baltimore, MD (US); Kenny H. Otwell, Columbia, MD (US); Jose Luis Henriquez Galarza, Baltimore, MD (US)

(73) Assignee: Laureate Education, Inc., Baltimore, MD (US)

(21) Appl. No.: 14/476,033

(22) Filed: Sep. 3, 2014

Related U.S. Application Data
(60) Provisional application No. 61/873,173, filed on Sep. 3, 2013.

(51) Int. Cl. G06Q 50/20; G06Q 30/02; G06Q 50/00; G06Q 10/00

(52) U.S. Cl. CPC G06Q 50/20; G06Q 10/00; G06Q 30/0241; G06Q 50/01
USPC 705/14.4; 705/326

(57) ABSTRACT

The system and method allows a user to share a portfolio with entities external to the learning management system, e.g. an employer, a potential employer, another learning institution, alumni, friends, family, any party interested in learning about the student's achievements. A portfolio may store all of the materials a user has worked on for one or more courses. Portfolios may also include user progress toward achieving standards at a granular level, such as academic competencies. System users may be able to search for portfolios based on one or more competencies to identify users that are qualified in a particular field or skillset. Through the portfolio web site, a user can share portions of the portfolios with other users via a URL. The URL or internet address may be specific to a student or provide general access to student portfolios. The entity may need to supply credentials, including a username, password, or PKI to access the portfolio associated with the URL or internet address.

### CROSS-RELATED APPLICATIONS

This application claims the benefit of the filing date of U.S. Provisional Application 61/873,173, filed Sep. 3, 2013 which is incorporated by reference herein in its entirety.

### FIELD

The present invention is generally directed to interfacing with student portfolios, and in particular, to learning systems and methods for interfacing with student portfolios.

### BACKGROUND

With developments in the education industry, students seek access to course-related information and their own course work, anywhere, anytime. Students want current, relevant, interesting and engaging course materials and assignments taught by teachers, instructors, counselors and advisors who are aware of student's educational and professional path and goals based on a clear map of course progress and degree program. Enabling and facilitating students' online activities around their campus is a major consideration in providing the desired student experience.

A learning management system (LMS), as referred to in the art, is software for delivering, tracking and managing training of students. LMSs range from systems for managing student training records to software for distributing courses over the Internet and offering features for online collaboration. In many instances, LMSs are used to automate record-keeping as well as to register students for classroom and online courses. Self-registration, faculty-led learning, learning workflow, the provision of on-line learning (e.g., read and understand), on-line assessment, management of continuous professional education (CPE), collaborative learning (e.g., application sharing, discussion threads), and learning resource management (e.g., instructors, facilities,

FIG. 1 depicts a known LMS 10, including ones offered by Blackboard, WebCT, Moodle, eCollege and others, which allows a faculty member to place his or her courses, in whole or in part, online. As depicted, the faculty 12 plays a central role for mediating between a student 13, presenting course content 15 and assessing a student 14. LMSs 10 usually provide all-inclusive learning environments for faculty and students, with the faculty 12 or a course developer disseminating instructional material specific to a course of study amongst students. As such, the faculty member serves as the facilitator, assessor and content developer.

Conceptually, there is no difference between the role of a teacher in conventional LMSs 10 and the role of a teacher in a bricks and mortar classroom. In both cases, the students are grouped and assigned a specific teacher. The teacher introduces all course content and materials into the classroom and mediates and assesses the learning process of the student. Thus, the LMS 10 is a tool to replicate, as closely as possible, the traditional classroom environment and the LMS 10 is limited by its system boundaries, just as the physical classroom is limited by four walls and doors.

Social networking sites share a variety of technical features that allow individuals to: construct a public/semi-public profile, articulate a list of other users that they share a connection with, and view their list of connections within the system. The most basic of these are visible profiles with a list of “friends” who are also users of the site. A profile is generated from answers to questions, such as age, location, interests, etc. Some sites allow users to upload pictures, add multimedia content, or modify the look and feel of the profile. Others, e.g., Facebook, allow users to enhance their profile by adding modules or “Applications.” Many sites allow users to post blog entries, search for others with similar interests and compile and share lists of contacts. User profiles often have a section dedicated to comments from friends and other users. To protect user privacy, social networks typically have controls that allow users to choose who can view their profile, contact them, add them to their list of contacts, and so on. Some social networks have additional features, such as the ability to create groups that share common interests or affiliations, upload or stream live videos, and hold discussions in forums.

Companies have begun to merge business technologies and solutions, such as cloud computing, with social networking concepts. Instead of connecting individuals based on social interest, companies are developing interactive communities that connect individuals based on shared business needs or experiences. Many provide specialized networking tools and applications that can be accessed via their websites, such as LinkedIn. Others companies, such as Monster.com, have been steadily developing a more “socialized” feel to their career center sites to harness some of the power of social networking sites. These more business related sites have their own nomenclature for the most part but the most common naming conventions are “Vocational Networking Sites” or “Vocational Media Networks”, with the former more closely tied to individual networking relationships based on social networking principles.

The current system of awarding grades to signify student achievement lacks specificity. An assignment rubric usually contains multiple dimensions, but the student is awarded a single grade for the assignment. Therefore, the student may not recognize the need to improve in a specific dimension. Further, grades signal little about that student to a potential employer, nor do they provide examples of a student's actual work products for a potential employer to review.

There are systems that an individual can use to create a digital gallery or portfolio, but these systems fail to provide academic certification. For example, these systems may have information supplied by students, so a potential employer or other interested party cannot be certain that the information is correct. So-called ePortfolio systems also fail to tell a potential employer anything about the individual's ability to problem-solve, collaborate with others, think critically, or communicate effectively—high-order skills that are critical to professional success in the 21st century.

To date, there are no unified systems that create a complete profile of an individual's academic achievement (including the development of high-order skills) as well as provide examples of that individual's work products. Additionally, no systems create the complete profile, for a variety of professions, of an individual's academic achievement that provides an assurance, e.g. the backing of an accredited institution, that the information is correct and/or reliable. There are also no systems that map portfolio items to multiple standards for various professions, so that profiles may be managed for different careers. Nor are there systems that allow for collaborative profiles that include contributions from multiple users.

With advances in information technologies, there exists a need for an educational system that addresses the aforementioned problems.

### SUMMARY

Briefly, this document describes a robust system for:

Tracking a student's achievements throughout his/her academic career;

Displaying a visual representation for each area of skill or knowledge the student has demonstrated;

Mapping achievements to professional standards and higher-education accreditation requirements (where applicable);

Utilizing predominant standards for metadata describing such visual symbols;

Displaying digital copies of the student's work products;

Enabling and managing group contributions to a work product; and/or

Sharing achievements and work products with authorized users of the system both within and outside of the institutional community.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

Embodiments will now be described in connection with the associated drawings, in which:

FIG. 1 depicts a known LMS.

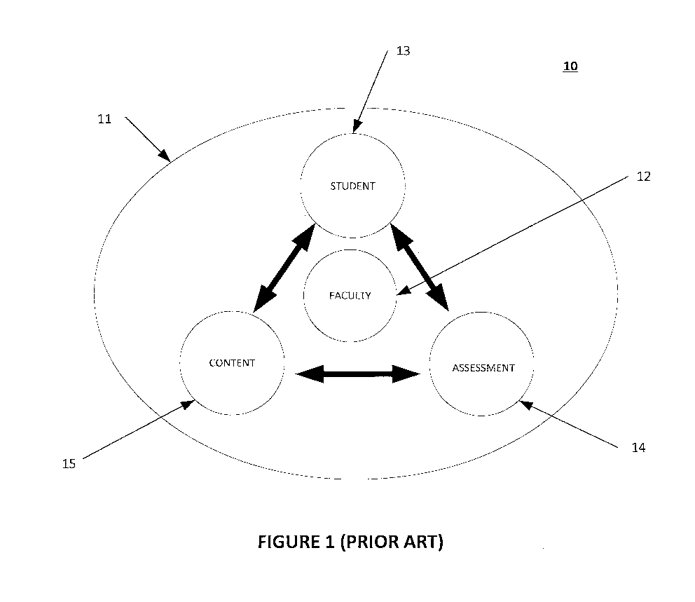

FIG. 2 depicts an exemplary educational system in accordance with one or more embodiments.

FIG. 3 depicts an exemplary block diagram of a network having a front-end system and a back-end system in accordance with one or more embodiments.

FIG. 4 depicts an exemplary server in accordance with one or more embodiments.

FIG. 5 depicts an exemplary logic flow for providing student portfolios in accordance with one or more embodiments.

FIG. 6 depicts an exemplary block diagram of a mapping of institution standards to certification authority standards in accordance with one or more embodiments.

### DETAILED DESCRIPTION OF THE DRAWINGS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

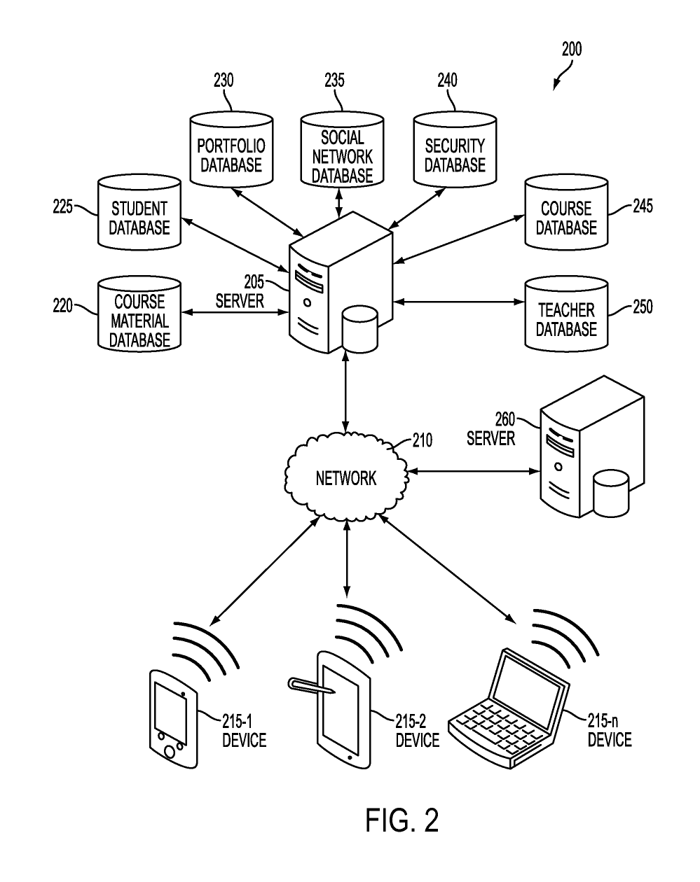

FIG. 2 depicts an exemplary educational system 200 in accordance with one or more embodiments. In one embodiment, users of devices 215-1 through 215-n may register within a particular learning system or institution and may connect to a network 210 (e.g. the Internet). Each of devices 215-1 through 215-n may be a computer, workstation, mobile device, a PDA, an iPad, or a laptop computer. A server 205 may be maintained by the school/university or a third party vendor. Education system 200 may also include a server 260. Server 260 may include any combination of features of server 205. Server 260 may also be connected to the other parts of education system 200 through network 210. Server 260 may be located on the same network as server 205 or on a different network as server 205. Server 260 may run or operate other instances of the software used to provide the online education system. Server 260 may be run or operated by other institutions, either foreign or domestic. Server 260 may be run or operated by the same institution but in separate locations, either foreign or domestic. Education system 200 may include any number of additional servers, user devices, or network connections.

Server 205 may be connected to or include a number of databases, including a course material database 220, a student database 225, a portfolio database 230, a social network database 235, a security database 240, a course database 245, a teacher database 250, or any combination thereof. The course material database 220 may store any information about course materials. The course material database 220 may store, for each course, weekly schedules, syllabi, assignments, resources, due dates, discussions, reflections, content summaries, content reviews, quizzes, tests, midterms, finals, any other course material information, or any combination thereof.

Student database 225 may store any information about students using the system. Student database 225 may store an inventory of all users that are affiliated with the particular learning program or institution. In one embodiment, such users are associated with network address, e.g., IP addresses, that may be stored in a user's profile. Student database 225 may store information about the students' names, class year, programs of study, locations, addresses, information about the students entered by the students, activities and interests of the students, education of the students, work experiences of the students, pictures of the students, or any combination thereof.

Portfolio database 230 may store information about student portfolios. Student portfolios include information about student progress in the courses. Portfolio database 230 may store information about courses the students have completed, activities the students have completed, examples of work products the students have completed, grades, evaluations, rankings, or any combination thereof.

Social network database 235 may store social networking information about the users of the system. Social networking information may include contacts of the users to which the students are connected, circles of the users, chat connections of the users, chat histories of the users, communities of the users, courses associated with the users, or any combination thereof. As used herein, a circle of a user means a set of other users associated with a user in the system. In one embodiment, a user's circles may be set by the user. As used herein, a community of the user may include any group or association of which the user is a part as identified by the system. Communities are different from contacts and circles because communities cannot be directly modified by users. Communities may be disbanded once a course ends, or past communities may be maintained. Social network database 235 may also store any other information related to the social networking information.

Security database 240 may store security information for the system. Security information may include usernames of the users, passwords of the users, security questions used for verifying the identity of the users, answers to security questions, which parts of the system the users are able to access, or any combination thereof.

Course database 245 may store any information about the courses offered by educational system 200. Course database 245 may store course names, course identifiers, course numbers, course descriptions, course teachers, course teaching assistants, course schedules, course enrollment including students enrolled in the courses, past course offerings, future course offerings, number of users allowed to enroll in a course, course structure, course prerequisites, or any combination thereof.

Teacher database 250 may store any information about the teachers using educational system 200. In one embodiment, teachers are associated with network address, e.g., IP addresses, that may be stored in a teacher's profile. Teacher database 250 may store information about the teachers' names, years teaching, programs involved with, locations, addresses, information about the teacher entered by the users, activities and interests of the teachers, education of the teachers, work experiences of the teachers, pictures of the teachers, or any combination thereof.

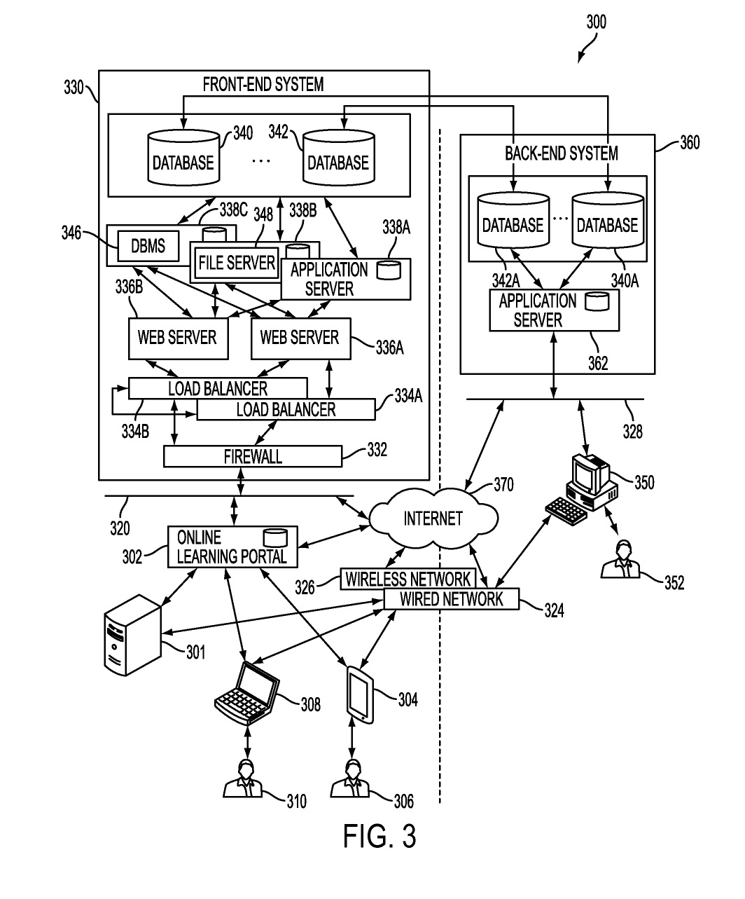

FIG. 3 depicts an exemplary block diagram 300 of a network having a front-end system and a back-end system in accordance with one or more embodiments. The front-end system 330 includes a firewall 332, which is coupled to one or more load balancers 334a, 334b. Load balancers 334a-b are in turn coupled to one or more web servers 336a-b. To provide online learning sessions, the web servers 336a-b are coupled to one or more application servers 338a-c, each of which includes and/or accesses one or more front-end databases 340, 342, which may be central or distributed databases. The application servers serve various modules used for interaction between the different users and the learning system, including instructional enrollment module, course registration module, learning session management module, content delivery module, proximity module, event module, a social networking tool, connection layer module, external portfolio module, internal portfolio module, a presentation module, or any combination thereof. These modules may be run independently of each other based on corresponding teacher, student, geolocation and event profiles, as further described below.

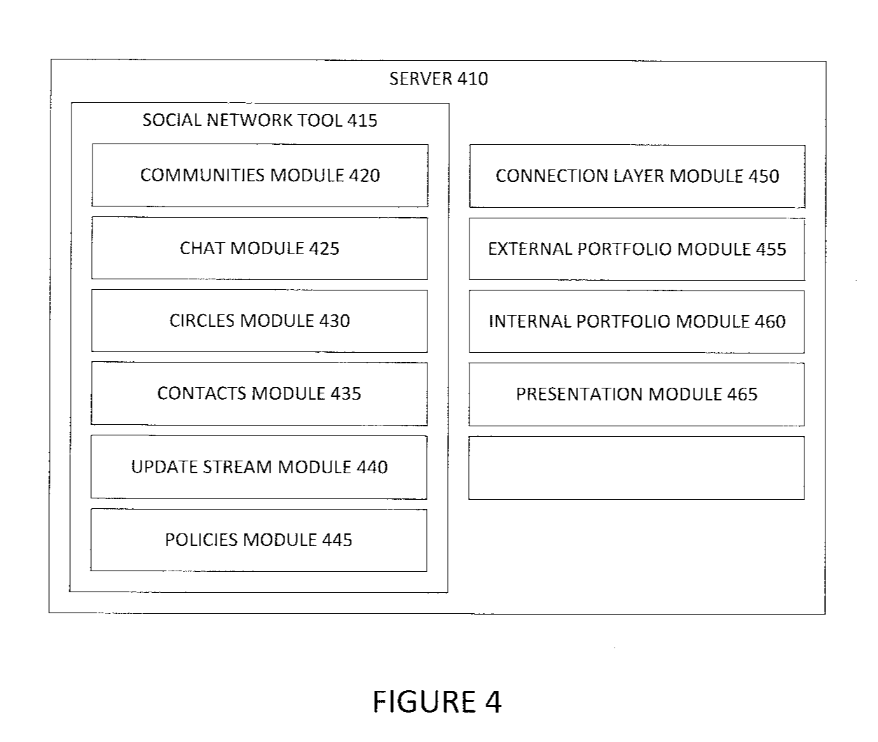

Web servers 336a-b provide various user portals, including student, teacher, and event portals. The user portals may include various web interfaces. The servers 336a-b are coupled to load balancers 334a-b, which perform load balancing functions for providing optimum online session performance by transferring client user requests to one or more of the application servers 338a-c according to a series of semantics and/or rules. The application servers 338a-c may include a database management system (DBMS) 346 and/or a file server 348, which manage access to one or more databases 340, 342. In the exemplary embodiment depicted in FIG. 4, the application servers 338a and/or 338b provide instructional content to the users 306, 310 which include electronic interfaces, progress reports, student profiles, teacher profiles, event profiles, as well as instructional content correlated with a student, teacher, course, school, expressive avatar information or event as processed by the server. Some of the instructional content is generated via code stored either on the application servers 338a and/or 338b, while some other information and content, such as student profiles, instructional material, teacher schedule, or other information, which is presented dynamically to the user, is retrieved along with the necessary data from the databases 340, 342 via application server 338c. The application server 338b may also provide users 306, 306 access to executable files which can be downloaded and installed on user devices 304, 310 for creating an appropriate learning environments and sessions, with branding and or marketing features that are tailored for a particular application, client or customer.

The central or distributed database 340, 342, stores, among other things, the web content and instructional material deliverable to the students. The central or distributed database 340, 342, may store information stored in course material database 220, student database 225, portfolio database 230, social network database 235, security database 240, course database 245, teacher database 250, or any combination thereof. The central or distributed database 340, 342 may also store retrievable information relating to or associated with students, teachers, responsible authorities, parents, learning centers, profiles (student, facilitator, teacher, faculty, course developer, assessor, etc.), billing information, schedules, statistical data, attendance data, enrollment data, teacher attributes, student attributes, historical data, demographic data, compliance data, certification data, billing rules, third party contract rules, educational district requirements, expressive avatar information, etc. Any or all of the foregoing data can be processed and associated as necessary for achieving a desired learning objective or a business objective associated with operating the system of the disclosed embodiments.

Updated program code and data are transferred from the back-end system 360 to the front-end system 330 to synchronize data between databases 340, 342 of the front-end system and databases 340a, 342a of the back-end system. Further, web servers 336a, 336b, which may be coupled to application servers 338a-c, may also be updated periodically via the same process. The back-end system 360 interfaces with a user device 350 such as a workstation, enabling interactive access for a system user 352, who may be, for example, a developer or a system administrator. The workstation 350 may be coupled to the back-end system 360 via a local network 328. Alternatively, the workstation 350 may be coupled to the back-end system 360 via the Internet 370 through the wired network 324 and/or the wireless network 326.

The back-end system 360 includes an application server 362, which may also include a file server or a database management system (DBMS). The application server 362 allows a user 352 to develop or modify application code or update other data, e.g., electronic content and electronic instructional material, in databases 340a, 342a. According to one embodiment, interactive client-side applications on the internet execute on a variety of internet delivery devices such as a web-browser, smart phones, and tablet devices such as the iPad, to provide an improved core student experience.

FIG. 4 depicts an exemplary server 410 in accordance with one or more embodiments. Server 410 may include a social network tool 415, a connection layer module 450, an external portfolio module 455, an internal portfolio module 460, a presentation module 465, or any combination thereof. Social network tool 415 may include a communities module 420, a chat module 425, a circles module 430, a contacts module 435, an update stream module 440, a policies module 445, or any combination thereof. The modules may provide the functionalities as further described below.

Portfolios

The system may be implemented as a part of an online learning management system that allows an entity access to portions of a student's educational history in the form of a portfolio. The portfolio may be a collection or summary of all or portions of a student's work or educational history. Portfolios may also include user progress toward achieving standards at a granular level, such as academic competencies. System users may be able to search for portfolios based on one or more competencies to identify users that are qualified in a particular field or skillset. For example, educational system 200 may allow an entity access to portions of a student's educational history. The portfolio may be a collection or summary of a student's work or educational history. In some embodiments, the portfolio would not include all aspects of a student's history, but only a summary of the student's history.

The system may allow a user to share a portfolio with entities external to the learning management system, e.g. an employer, a potential employer, another learning institution, alumni, friends, family, any party interested in learning about the student's achievements. The system may provide an external portfolio web site having a URL or other form of internet address. The URL or internet address may be specific to a student or provide general access to student portfolios. An entity may use the URL or internet address to access the external portfolio web site. The entity may need to supply credentials, including a username, password, or PKI to access the portfolio associated with the URL or internet address. The credentials may be associated with a particular student, and the student may supply the credentials to the entity.

A portfolio may store all of the materials a user has worked on for one or more courses. Through the portfolio web site, a user can share portions of the portfolios with other users. A user may be presented with an interface that allows the user to select, for each potential portfolio element, whether the item is included or excluded from the portfolio to share. Each user may create any number of portfolios to share. A user, community, or group of users may create portfolios to share, and the portfolios may be shared with another user, community, group of users, or combinations thereof. The portfolio may be used as a place for students to upload work to be graded by an instructor or other assessor.

All or portions of a portfolio may be ranked and/or commented on. Users may rate and/or comment on shared portfolio material, which provides the benefit of allowing users to quickly identify the most useful, popular, liked, or most relevant shared portfolio material. The ratings and/or comments may provide information about and/or be directed toward the usefulness, popularity, likeability, or relevance of portfolio material. The ratings and/or comments may also be specific to an individual's skills in a particular area. For example, a commenter, such as a classmate or instructor, may provide a comment with detailed information about class project that is in another user's portfolio. The comments may be moderated user whose portfolio material is being commented on, an administrator, an instructor, a content moderator, another user, or any combination thereof. For example, an instructor may notice inappropriate remarks in a comment, e.g. disparaging comments, vulgarity, etc., and remove the comment from being displayed and/or associated with the portfolio material.

For example, educational system 200 may provide an external portfolio web site having a URL or other form of internet address. The URL or internet address may be specific to a student or provide general access to student portfolios. A student could use the external portfolio web site to share the student's portfolio with an entity. In some embodiments, the entity could be an employer, a potential employer, another learning institution, alumni, friends, family, any party interested in learning about the student's achievements, or combinations thereof. An entity may use the URL or internet address to access the external portfolio web site. The entity may need to supply credentials, including a username, password, PKI, or combination thereof to access the portfolio associated with the URL or internet address. The credentials may be associated with a particular student. The student may supply the credentials to the entity. Policies module 445 may compare the entered credentials associated with the URL, internet address, or student with credentials associated with the URL, internet address, or student in security database 240. If the credentials match, the entity may be provided access to a web site displaying the student's portfolio. External portfolio module 455 may manage the aspects related to providing an external portfolio as described herein.

Several benefits are provided by providing access to a portfolio to an entity. First, the entity would not have to rely on a student-supplied resume but could instead access an institution-supplied record of student work and progress. Second, because the information would be managed by the institution, the site and portfolio would not be subject to falsification and would provide an authoritative record to the entity about the student.

A student portfolio may be customizable in order to optimize the portfolio for retrieval by search engines. For example, a user may be allowed to enter tags and/or keywords to be associated with the portfolio. Those keywords may be used by the search engine to index the portfolio or rank the portfolio higher with respect to the entered tags and/or keywords.

The appearance of a student portfolio may be customizable. A user may select one or more themes, templates, and/or skins to be applied to the portfolio when being presented to users viewing the portfolio.

Educational system 200 may provide an internal portfolio web site having a URL to users of the system. An internal portfolio may store all of the materials a user has worked on for courses. Through the internal portfolio web site, a user can share portions of the portfolios with other users. A user may be presented with an interface that allows the user to select, for each potential portfolio element, whether the item is included or excluded from the portfolio to share. Each user may create any number of portfolios to share. A user, work-group, community, or circle may create portfolios to share. A user, work-group, community, or circle may share portfolios with another user, community, circle, or combinations thereof. The same techniques for rating, commenting on, and distributing educational content described in Laureate Education Inc.'s U.S. Patent Publication No. 2009-0311658 A1 may be used to rank, comment on, and distribute portfolios.

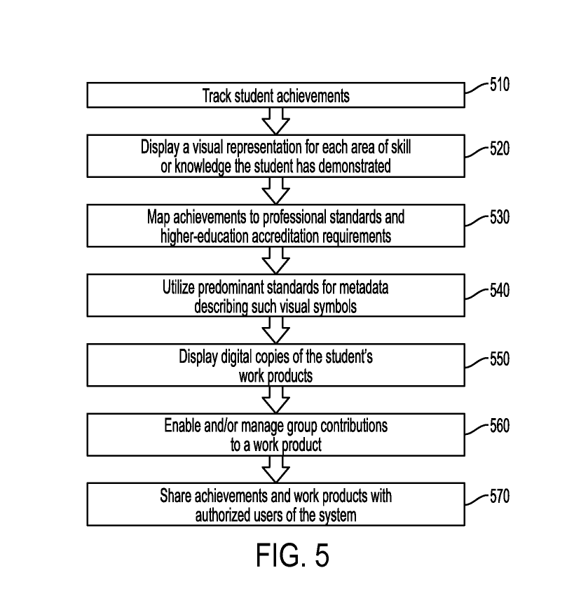

FIG. 5 depicts an exemplary logic flow for providing student portfolios in accordance with one or more embodiments.

1. Tracking Student Achievements

In block 510, student achievements may be tracked. The system will have the capability to ingest information about the student's performance on academic assignments, and to store and aggregate that information. Sources of information may include:
A direct integration with the Learning Management System (LMS), e.g., via direct or indirect access to one or more databases of the LMS, which may: capture the overall grade on an assignment; and/or capture points on each dimension of a grading rubric, if the LMS provides rubrics-based grading tools;
Manual entry from an institutional authority, such as: Faculty or other teaching staff; and/or Authorized administrators;
Externally provided certification, such as professional examinations. For example, the system may receive information from sources that can provide information about a user's performance on a state bar exam, a professional engineering certification exam, medical boards, certification by a national association, or any professional examination or accreditation standard; and/or
Information transferred from another academic institution. For example, information may be received via direct or indirect access to one or more databases of the other academic institution, over a network, any other source from another academic institution, or any combination thereof

Inputs to the system will result in documentation of that student's achievements. Such documentation will be represented in an easily understood visual display. For example, the document may be in the form of a user interface, web page, application screen, or any combination thereof.

Achievements may include meta skills. Meta skills may refer to skills that apply to multiple disciplines or to general abilities of students applicable across multiple disciplines. For example, meta skills may include working well with others, problem solving ability, the ability to work well in a team, leadership skills, etc.

2. Displaying a Visual Representation for Each Area of Skill or Knowledge the Student has Demonstrated

In block 520, a visual representation for each area of skill or knowledge the student has demonstrated may be displayed. The system may be capable of displaying visual representations of the student's achievements. Such visual representations may include:
Charts or graphs denoting the student's percentage of achievement in comparison to a numerical standard,
Visual symbols such as badges, and/or stars, and
Comments from classmates, faculty, and others designated by the student.

The visual representation, such as a badge, may be a certification of a person having a certain competency.

3. Mapping Achievements to Professional Standards and Higher-Education Accreditation Requirements

In block 530, achievements to professional standards and higher-education accreditation requirements may be mapped. The system will be able to ingest relevant standards and map them to skills and knowledge that are tracked in the system. These standards may include:
Higher education accreditation boards. For example, the National Council for Accreditation of Teacher Education (NCATE) has highly detailed standards for teacher preparation;
Professional organizations. For example, the National Association of Manufacturers maintains a skills certification system; and/or
Common standards for higher education. For example, the Lumina Foundation has published a Degree Qualifications Profile describing the skills and knowledge that should be acquired by all college students.

The system may be able to import multiple standards. For example, the system may import standards from both NCATE and the National Association of Manufacturers. Then, the relevant standards may be mapped to skills, knowledge, and/or achievements that are tracked by the system. Often, a skill, knowledge, and/or achievement track by the system may be mapped to a single item of a single standard. However, in some instances, a skill, knowledge, and/or achievement may be mapped to multiple items of a single standard, multiple items from different standards, or any combination thereof.

These external standards will be mapped to matching items in the system's taxonomy. Anyone viewing a student's achievements will be able to select one of the standards and immediately see the student's achievements in context. For example, when viewing a student's portfolio containing an achievement, a portfolio entry, an achievement tracked by the system, a standard, a description of what the standard is or means, a link to or pop-up window of a description of what the standard is or means, or any combination thereof. The standard item may also be identified by an identifier, which may be displayed with the any of the other information displayed for a student portfolio.

Standards and/or items of a standard may be mapped to work products, course outcomes, or any other measureable facet of a student's progress that is tracked by the system.

The mapping of standards and/or items of a standard to one or more skills and/or knowledge tracked by the system may be stored in one or more data structures capable of storing the relationships, e.g. a table. The following table provides an example:

| | |
|---|---|
| Assignment #1 | Standard #1 |
| Assignment #2 | Standard #1, Item #3 |
| Assignment #2 | Standard #2 |
| Work Product #4 | Standard #1, Item #3 |
| Course outcome #5 | Standard #4 |

The preceding table shows the mapping between various skills and/or knowledge tracked by the system (the column on the left) and standards and/or items of a standard (the column on the right). As an example, Work Product #4 may represent a lesson plan developed by a teaching student. Standard #1 may relate to a national teaching standard, and Item #3 may be a particular competency in developing lesson plans.

The mapping from the standards to the skills and knowledge may be performed in various ways. In some embodiments, the mapping may be performed manually. A user could provide the system, via an interface, data file, or other form of data entry, with the mappings. In some embodiments, the system may perform the mapping itself. The system may be configured to receive from a data source a standard, the skills and knowledge, or any combination thereof. For a given standard, the system may traverse the standard and, for each or any item, perform a keyword search, e.g. using keywords found in the standard or standard items, on the skills and knowledge items. For one or any of the matches, the system may map the standard and/or standard item to the match. Although this example depicts processing the standard, it is understood that the skills and knowledge tracked by the system could be processed, and then one or more standards could be searched for corresponding matches. In some embodiments, the system may create a mapping, which is then reviewed for accuracy and/or correctness by a user. The user may confirm the mappings produced by the system, or add, edit, or delete mappings. When satisfied with the mappings, the user may indicate that the mappings are finalized and to be used when displaying entries to which the standard applies.

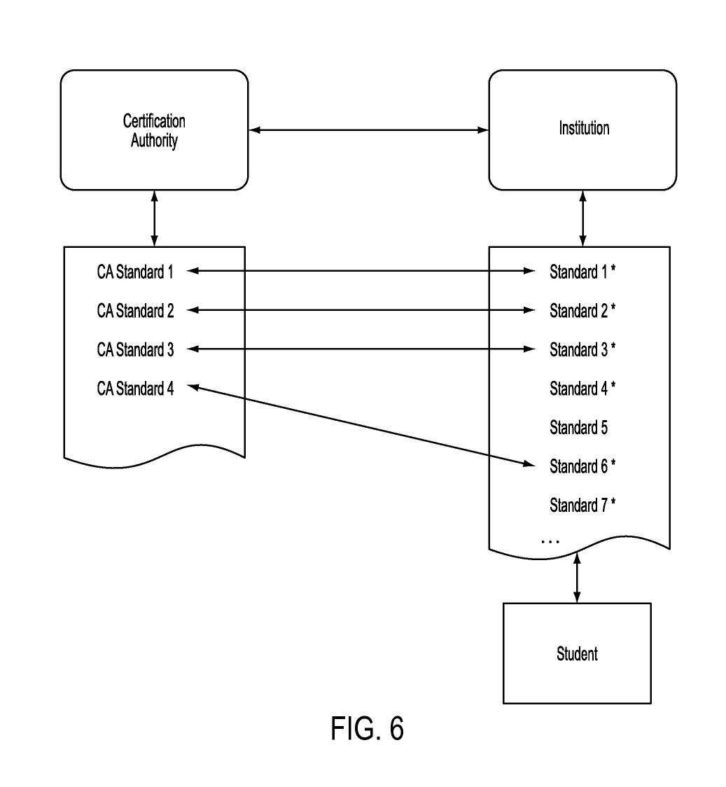

FIG. 6 depicts an exemplary block diagram of a mapping of institution standards to certification authority standards in accordance with one or more embodiments. As discussed above, the certification authority might have require certain standards to be met, e.g. CA Standards 1-4, be a certification may be provided. An institution may be authorized by the certification authority to indicate that a student has met the certification authority's standards and is therefore entitled to the certification. Instead of using the certification authority's standards, the institution may develop its own standards, e.g. Standards 1-7. Although the institutions standards are discussed using the term standards, it is to be understood that the standards may relate to the completion and/or measure of performing competencies, e.g. achieving a high enough grade on an exam, completing a project, etc. As discussed above, the institution standards may be mapped to the certification authority's standards. For example, CA Standard 1 may be mapped to Standard 1, CA Standard 2 may be mapped to Standard 2, CA Standard 3 may be mapped to Standard 3, and CA Standard 4 may be mapped to Standard 6. The asterisk next to the institutional standards may visual representations of the standards that a student has met. For example, the asterisk next to Standard 1 may be a badge representing 100% completion of a particular course. Because the student has met all certification authority standards by achieving the corresponding institutional standards, the institution may certify the student has having earned the certification represented by completion of the certification authority's standards.

Although a single institution is shown, it is to be understood that multiple institutions may each have at least one standard that is mapped to at least one of the certification authority's standards. A student may attend the multiple institutions and complete institutional standards in different institutions. If the student completes all of the institutional standards that map to the certification authority's standards for a certification, one of the multiple institutions, a group of the multiple institutions, or the certification authority may certify the student has having achieved the certification. In some embodiments, one or more of the student's achievements of the institutional standards may need to be verified by the body issuing the certification. Using this model, the student may earn the necessary certification without being tied to a particular institution.

4. Utilizing Predominant Standards for Metadata Describing Such Visual Symbols

Referring back to block 540 of FIG. 5, predominant standards for metadata describing such visual symbols may be utilized. Metadata will be attached to each representation of achievement. These metadata will adhere to one or more predominant standard(s) so that achievements can be transferred between this and other systems utilizing the same metadata standards. Such standards may include:
Mozilla's “Open Badges” standard; and/or
The Tin Can API

The metadata may include information about the specific achievement, e.g. achievements, skills, and/or knowledge tracked by the system, standards, standard items, any representation thereof, or any combination thereof. The metadata may include information for verifying the specific achievement represented by the representation of achievement, or information that allows the specific achievement to be traced back to an institution, accreditor, or authority. For example, the metadata may be digitally signed by an institution or include a link to a web page provided by an institution to verify the authenticity of the metadata.

5. Displaying Digital Copies of the Student's Work Products

In block 550, digital copies of the student's work products may be displayed. In addition to providing certification of students' achievements, the system will also be able to display examples of a student's work, such as documents, static images, video and audio clips, interactive media, programming code, and work containing multiple forms of content. Where applicable, the sample work products will be hyperlinked to relevant achievements, and may appear on the same web page as the symbols certifying those achievements.

Items may be selected for inclusion into a portfolio in many different ways. For example, as discussed above, a student may self-select items for inclusion. Other users, e.g. students, faculty, teachers, assessors, etc. may also suggest content for inclusion. This content may be included upon being suggested, or the user may be required to confirm the selection prior to being included. The LMS may also suggest items for inclusion. For example, the LMS may, based on the mappings, identify one or more items that meet a professional standard or standard item. Then, the item may be suggested based on having that mapped achievement. The user may have the ability to confirm inclusion by items suggested by the system, or the items may be automatically included. In some embodiments, the LMS may suggest items for inclusion based on grading information, e.g. rubric scores that exceed a scoring threshold, for inclusion into the portfolio.

6. Enabling and Managing Group Contributions to a Work Product

In block 560, group contributions to a work product may be enabled and/or managed. The system will be capable of tracking achievements of collaborative teams as well as achievements of individuals. In addition, the system will present tools and centralized file storage enabling collaborative activities. Collaborative achievements will be listed on each individual's record, and will clearly indicate:
The individual's role in the collaborative effort,
The number of other participants and their roles, and
The names of the other participants if they have opted to allow their names to be revealed on each other's records.

For example, the system may include a portfolio entry for a group project. The project may have been performed by a photography student, a design student, and a writing student. The project may have been to create a marketing brochure. The photography student may have taken a picture for the brochure, the writing student may have written a description for the brochure, and the design student may have assembled the brochure using the picture and description. The project may be included in the portfolio of any of the users. For example, the project may be an entry in the design student's portfolio. Along with displaying the project, the system may display an indicator of the design student's involvement. For example, a message may be displayed that the design student designed the brochure, achieved a design achievement for his/her contribution to the project, and display a standard and/or standard item associated with that achievement. The system may also indicate that two other students worked on the project, along with the roles the other students performed. The system may also indicate who the other students were, so that a user viewing the design student's portfolio could access the writing student's profile or the photography student's profile.

7. Sharing Achievements and Work Products with Authorized Users of the System Both within and Outside of the Institutional Community

In block 570, achievements and work products may be shared with authorized users of the system. Authorized users of the system that have achievements and work products shared with them may be within and/or outside of the institutional community. There are several ways that student achievements may be shared. These may include:
Students invites a potential employer to view his/her records,
Student invites other students to view his/her records and post ratings or comments on sample work products,
Student invites other students to view his/her work as a proxy for the quality of the institution, academic program, or course,
Prospective student uploads work products as part of an application to matriculate, and
Institution shares selected student work with prospective students for marketing purposes (with permission of the student who created the work).

Security and privacy are maintained by providing the individual with several choices for how to share the portfolio:
Share with your classmates/instructor only
Share with your institution
Share with the Laureate network of institutions
Share with invitees from inside or outside the Laureate network
Just make it public, open to all, searchable by search engines

The system provides search tools that will allow a user to search public portfolios in a variety of ways, for example:

a) Filter by tags
b) Find by badge
c) Find by rating in a category
d) Find all in a category

Users who are viewing or searching in the system should be able to identify themselves in a variety of ways, including but not limited to:

a) Prospective Employer (name and/or company is displayed)
b) Prospective Employer (anonymous)
c) Job seeker
d) Prospective student

### e) Instructor

### f) Student

### g) Friend

### h) Anonymous

### CONCLUSION

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

Various embodiments may comprise one or more elements. An element may comprise any structure arranged to perform certain operations. Each element may be implemented as hardware, software, or any combination thereof, as desired for a given set of design and/or performance constraints. Although an embodiment may be described with a limited number of elements in a certain topology by way of example, the embodiment may include more or less elements in alternate topologies as desired for a given implementation.

It is worthy to note that any reference to “one embodiment” or “an embodiment” means that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of storage media include hard drives, disk drives, solid state drives, and any other tangible storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

While certain features of the embodiments have been illustrated as described above, many modifications, substitutions, changes and equivalents will now occur to those skilled in the art. Thus, the breadth and scope of the present invention should not be limited by any of the above-described exemplary embodiments.

What is claimed is:

1. A method for providing access to a student portfolio of a student, the method comprising:
creating the student portfolio including:
receiving information on a student's achievements throughout their academic career;
displaying a visual representation for each area of skill or knowledge the student has demonstrated;
mapping achievements to professional standards and higher-education accreditation requirements;
displaying digital copies of the student's work products;
enabling and managing group contributions to a work product; and
sharing achievements and work products with authorized users of the system both within and outside of an institutional community;
receiving a request for the student portfolio over a network at an address, wherein the request comprises credentials;
comparing the received credentials with credentials associated with the student in a database; and
providing, via a portfolio website, access to the student portfolio based on the result of the comparison, wherein the student portfolio is an authoritative record about the student;

2. The method of claim 1, wherein the entity comprises at least one of an employer of the student, a potential employer of the student, a learning institution, an alumnus, a friend, a family member of the student, or any combination thereof.

3. The method of claim 1, wherein the portfolio is an institution-supplied record of student work, student progress, student educational history, or any combination thereof.

4. The method of claim 1, wherein the credentials comprise a username, a password, a public key infrastructure credential, or any combination thereof.

5. The method of claim 1, wherein the credentials are associated with the student.

6. The method of claim 1, wherein the credentials are provided to the entity by the student.

7. The method of claim 1, wherein the student portfolio includes a summary of the student's information.

8. The method of claim 1, wherein the address is specific to the student.

9. The method of claim 1, wherein the address is to a website that provides general access to student portfolios.

10. A system for providing access to a student portfolio of a student, the system comprising:
a memory; and
a processor coupled to the memory configured to:
receive a request for the student portfolio over a network at an address, wherein the request comprises credentials;
compare the received credentials with credentials associated with the student in a database; and
provide, via a portfolio website, access to the student portfolio based on the result of the comparison, wherein the student portfolio is an authoritative record about the student.

11. A computer readable storage medium comprising instructions that when executed by a processor cause the processor to:
receive a request for the student portfolio over a network at an address, wherein the request comprises credentials;
compare the received credentials with credentials associated with the student in a database; and
provide, via a portfolio website, access to the student portfolio based on the result of the comparison, wherein the student portfolio is an authoritative record about the student.

12. The method of claim 1, wherein the student's achievements include at least one of overall grade on an assignment; points on each dimension of a grading rubric

13. The method of claim 1, wherein the visual display includes include at least one of charts or graphs denoting the student's percentage of achievement in comparison to a numerical standard, visual symbols such as badges, and/or stars, and comments from classmates, faculty, and others designated by the student.

14. The method of claim 1, wherein mapping achievements include:
receiving from a data source a standard, the skills and knowledge for the standard, or any combination thereof;
for a given standard, traversing the standard and, for each item, performing a keyword search on the skills and knowledge;
determining matches; and
mapping the standard to the match.

15. The method of claim 1, wherein enabling and managing group contributions includes:
indicating the student's role in the collaborative effort, and
indicating a number of other participants and their roles.

16. The method of claim 1, wherein sharing achievements includes:
inviting a potential employer to view his/her records,
inviting other students to view his/her records and post ratings or comments on sample work products,
inviting other students to view work as a proxy for the quality of the institution, academic program, or course,
uploads work products of a prospective student as part of an application to matriculate, and
shares selected student work by the institution with prospective students for marketing purposes.
